(19) United States
(12) Patent Application Publication
(10) Pub. No.: US 2025/0180935 A1
(43) Pub. Date: Jun. 5, 2025

(54) SEMICONDUCTOR OPTICAL MODULATOR

(71) Applicant: Mitsubishi Electric Corporation, Tokyo (JP)

(72) Inventors: Eitaro ISHIMURA, Tokyo (JP); Harunaka YAMAGUCHI, Tokyo (JP); Akitsugu NIWA, Tokyo (JP)

(73) Assignee: Mitsubishi Electric Corporation, Tokyo (JP)

(21) Appl. No.: 18/843,881

(22) PCT Filed: Jun. 1, 2022
(86) PCT No.: PCT/JP2022/022324

§ 371 Date: Sep. 4, 2024

(51) Int. Cl. G02F 1/015

(52) U.S. Cl. CPC G02F 1/015

(57) ABSTRACT

A semiconductor optical modulator is formed by stacking a plurality of semiconductor layers including an optical modulation layer on a semiconductor substrate and emits light by modulating an intensity or a phase of light incident on the optical modulation layer. The optical modulation layer is formed using a digital alloy in which the semiconductor layers having a layer thickness of two or more atomic layers and having different constituent elements or composition ratios are alternately and repeatedly stacked.

### TECHNICAL FIELD

The present application relates to a semiconductor laser modulator.

### BACKGROUND ART

With the development of digital transformation utilizing digital information, communication networks for exchanging digital information and datacenters for storing and processing digital information have been remarkably developed. Optical communication is used for the communication networks and for communication within the datacenters, and in recent years, remarkable progress has been made in increasing the speed and capacity. Among them, a semiconductor optical modulator such as an electro-absorption (EA) modulator or a Mach-Zehnder (MZ) modulator (for example, refer to Patent Document 1) that is excellent in high-speed performance is used on a transmission side of the optical communication.

The EA modulator modulates light intensity by quenching (absorbing) or transmitting the laser light emitted from a semiconductor laser (LD: Laser Diode) in accordance with a digital signal of 0 or 1. The laser light modulated by the EA modulator can be modulated at a high speed, and wavelength spectrum spread during optical modulation is small, so that it can be transmitted over a long distance as compared with a method of direct current modulation of the LD. Thus, in recent years, these optical devices have been the most important in high-speed communication of 25 Gbit/sec or more. In addition, since the MZ modulator can perform phase modulation, the MZ modulator is used in multi-level modulation for digital coherent communication and in a transmission light source for long-distance communication.

Here, in an intensity modulator represented by the EA modulator or a phase modulator represented by the MZ modulator, a multiple quantum well (MQW) layer is mainly used as a layer (optical modulation layer) in which the intensity or phase of light is modulated by the change in the optical absorption coefficient or the refractive index. The quantum well has a structure in which a semiconductor layer (quantum well layer) having a small band gap is interposed between barrier layers having a band gap larger than that of the quantum well layer, and the multiple quantum well layer is formed by stacking a plurality of quantum wells. In the quantum well layer, hole level and electron level are discretely formed, holes and electrons are attracted to each other by Coulomb force to form excitons, and an energy difference ΔE between the hole level and the electron level is smaller than that before the excitons are formed.

A heavy hole level and a light hole level are formed in the holes, and when a voltage is applied, electrons and holes move to a low energy side and a high energy side, respectively, in the quantum well layer. Therefore, when the voltage is applied, the optical absorption energy by the excitons becomes smaller than that in the case where the voltage is not applied, and an optical absorption edge wavelength shifts to a long wavelength side. This is called a quantum-confined Stark effect, and light is modulated by using a change in the optical absorption coefficient or the refractive index due to a shift in the absorption edge wavelength (for example, refer to Non-patent Document 1). The EA modulator causes the MQW to function so as to change the optical absorption coefficient as the optical modulation layer, and the MZ modulator causes the MQW to function so as to change the refractive index as the optical modulation layer.

### PRIOR ART DOCUMENT

### Patent Document

Patent Document 1: Japanese Patent Application Laid-Open No. H03-290614

### Non-Patent Document

Non-patent Document 1: JOURNAL OF LIGHTWAVE TECHNOLOGY, (USA), 1988, VOL. 6, NO. 6, pp. 743

### SUMMARY OF INVENTION

### Problems to be Solved by Invention

However, a single semiconductor layer, that is, a bulk (random alloy) is typically used for the portion of the quantum well layer of the optical modulation layer described above. Therefore, in the vicinity of the absorption edge wavelength, in addition to exciton absorption due to the heavy holes, the exciton absorption due to the light holes occurs, and the wavelength half-width of the exciton absorption is widened by the electrical interaction between the heavy holes and the light holes. As a result, problems arise in that the loss in the vicinity of the absorption edge wavelength becomes large, the change in the absorption coefficient or the refractive index becomes small, and thus the propagation loss of light increases.

The present application discloses a technique for solving the above-described problems, and an object of the present application is to obtain a semiconductor optical modulator in which a change in the absorption coefficient or the refractive index is increased and the propagation loss of light is reduced.

### Means for Solving the Problems

A semiconductor optical modulator disclosed in the present application is formed by stacking a plurality of semiconductor layers including an optical modulation layer on a semiconductor substrate and emits light by modulating an intensity or a phase of light incident on the optical modulation layer. The optical modulation layer is formed using a digital alloy in which the semiconductor layers having a layer thickness of two or more atomic layers and having different constituent elements or composition ratios are alternately and repeatedly stacked.

### Advantageous Effect of Invention

According to the semiconductor optical modulator disclosed in the present application, since the wavelength half-width of the exciton absorption can be narrowed by applying the digital alloy to the optical modulation layer, it is possible to obtain a semiconductor optical modulator in which the change in the absorption coefficient or the refractive index is increased and the propagation loss of light is reduced.

### BRIEF DESCRIPTION OF THE DRAWINGS

FIG. 1A and FIG. 1B are a schematic cross-sectional view showing a configuration of a semiconductor optical modulator according to Embodiment 1 and an enlarged cross-sectional view of a part of a multiple quantum well optical modulation layer, respectively.

FIG. 2A and FIG. 2B are a band diagram of a well layer constituting the semiconductor optical modulator and a diagram in the form of a line graph showing wavelength dependence in an optical absorption coefficient and a refractive index change amount, according to Embodiment 1, respectively.

FIG. 3A and FIG. 3B show a band diagram of a well layer constituting a semiconductor optical modulator and a diagram in the form of a line graph showing wavelength dependence in the optical absorption coefficient and the refractive index change amount, respectively, according to a comparative example.

FIG. 4 is an enlarged cross-sectional view of a part of a multiple quantum well optical modulation layer of a semiconductor optical modulator according to Embodiment 2.

FIG. 5A and FIG. 5B are a band diagram of a well layer constituting the semiconductor optical modulator and a diagram in the form of a line graph showing wavelength dependence in the optical absorption coefficient, according to Embodiment 2, respectively.

FIG. 6 is an enlarged cross-sectional view of a part of a multiple quantum well optical modulation layer of a semiconductor optical modulator according to Embodiment 3.

FIG. 7A and FIG. 7B are a band diagram of a well layer constituting the semiconductor optical modulator and a diagram in the form of a line graph showing wavelength dependence in the optical absorption coefficient, according to Embodiment 3, respectively.

FIG. 8 is an enlarged cross-sectional view of a part of a multiple quantum well optical modulation layer of a semiconductor optical modulator according to Embodiment 4.

### MODE FOR CARRYING OUT INVENTION

### Embodiment 1

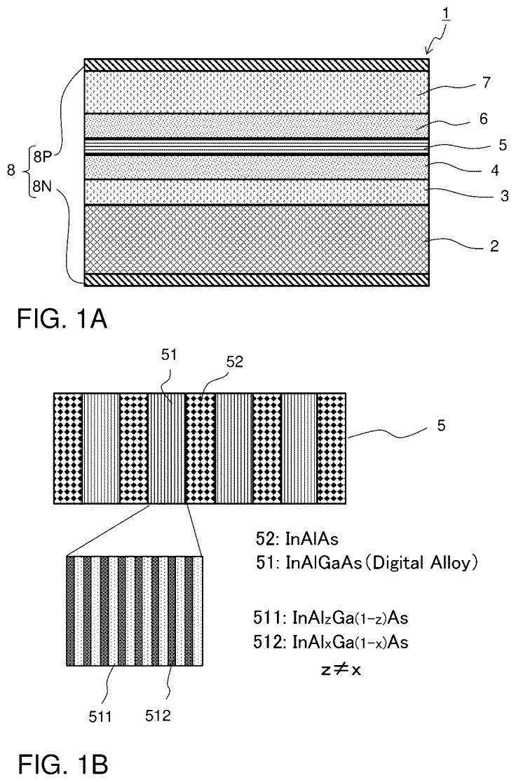

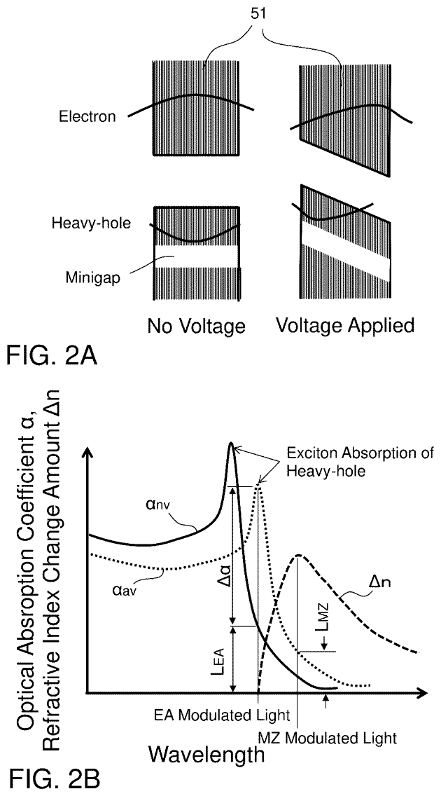

FIG. 1A and FIG. 1B, and FIG. 2A and FIG. 2B are for describing a configuration of a semiconductor optical modulator according to Embodiment 1, FIG. 1A is a schematic cross-sectional view showing a configuration of an EA modulator as the semiconductor optical modulator, and FIG. 1B is an enlarged cross-sectional view of a part of a multiple quantum well optical modulation layer among layers constituting the semiconductor optical modulator. FIG. 2A is a band diagram of a quantum well layer constituting the multiple quantum well optical modulation layer of the semiconductor optical modulator in the case where no voltage is applied and in the case where a voltage is applied, and FIG. 2B is a diagram in the form of a line graph showing wavelength dependence of an optical absorption coefficient and a refractive index change.

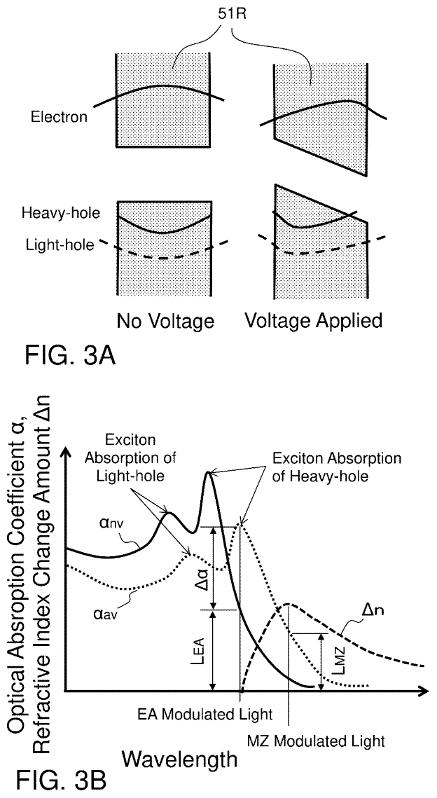

In addition, FIG. 3A and FIG. 3B are for describing characteristics of a semiconductor optical modulator having a multiple quantum well optical modulation layer of a typical structure as a comparative example, FIG. 3A is a band diagram of the quantum well layer constituting the multiple quantum well optical modulation layer of the semiconductor optical modulator in the case where no voltage is applied and in the case where a voltage is applied, and FIG. 3B is a diagram in the form of a line graph showing the wavelength dependence of the optical absorption coefficient and the refractive index change.

The semiconductor optical modulator of the present application is an EA modulator or an MZ modulator formed by stacking a plurality of semiconductor layers on a substrate so as to include the multiple quantum well optical modulation layer, and is characterized in that a digital alloy is applied to the multiple quantum well optical modulation layer. The definition of the digital alloy will be described later, and the basic configuration and operation characteristics of the semiconductor optical modulator will be described.

A typical method for forming a semiconductor layer, such as metal organic vapor phase epitaxy (MOVPE) or molecular beam epitaxy (MBE), can be applied to the semiconductor optical modulator according to Embodiment 1.

A case where the EA modulator is formed as a semiconductor optical modulator 1 will be described with reference to FIG. 1A. The MOVPE method or the MBE method is used to form, on an InP substrate 2, an n-type cladding layer 3 (or a buffer layer) of about 0.1 to 1 μm thickness, such as n-type InP, AlInAs, or the like having an approximate career concentration of 1×10¹⁸ to 5×10¹⁸ cm⁻³.

After an n-type optical confinement layer 4 composed of a single layer or a stacked layer of InGaAsP, InAlAs, InGaAlAs, or the like is grown thereon, a multiple quantum well optical modulation layer 5 is formed. The multiple quantum well optical modulation layer 5 is a multiple quantum well layer and functions as an optical modulation layer. A p-type optical confinement layer 6 formed of a single layer or stacked layers of InGaAsP, InAlAs, InGaAlAs, or the like, and a p-type cladding layer 7 of p-type InP, AlInAs, or the like having an approximate career concentration of 1×10¹⁸ to 5×10¹⁸ cm⁻³ are grown thereon. Then. an n-electrode 8N is formed on the side of the n-type InP substrate 2 and a p-type InGaAs contact layer (not shown) and a p-electrode 8P are formed on the side of the p-type cladding layer 7.

Here, in view of the problem of the increase in the wavelength half-width of the exciton absorption as described in the background art, the inventor of the present application has paid attention to preventing the spread of the level of the holes in the quantum well layer or the occurrence of a plurality of levels in order to narrow the wavelength half-width. Then, for example, it was considered that the level of the valence band or the conduction band of the material itself constituting the quantum well layer should be limited, and a material capable of limiting the level by a minigap was examined, and a material called a digital alloy was found.

Therefore, in the semiconductor optical modulator 1 according to Embodiment 1, as shown in FIG. 1B, the digital alloy is applied to a plurality of quantum well layers 51 between which barrier layers 52 are interposed in the multiple quantum well optical modulation layer 5. To be more specific, a first composition layer 511 made of i-type InAl_{z}Ga_{(1-z)}As with a composition ratio z and a thickness of two atomic layers, and a second composition layer 512 made of i-type InAlₓGa₍₁₋ₓ₎As with a composition ratio x and a thickness of two atomic layers are alternately grown and stacked up to a total thickness of about several nanometers. The composition ratio z and the composition ratio x are different from each other, and the average composition ratio (=(z+x)/2) of the two is set to be substantially the same as that of InAlGaAs of a typical random alloy.

Each of the barrier layers 52 has a thickness of several nanometers and is formed of i-type InAlAs or InAlGaAs having a band gap larger than that of InAlGaAs having the average composition ratio of the quantum well layer 51. The total thickness of the multiple quantum well optical modulation layer 5 is about 0.1 μm. The width and composition of the quantum well layer 51 are set such that an optical absorption edge is at a wavelength shorter than the wavelength of the light to be modulated by about several nanometers to several tens of nanometers.

Here, the multiple quantum well optical modulation layer 5 is described as the i-type layer, but may be a p-type or n-type layer as long as the carrier concentration is low and an electric field is applied to even a part of the multiple quantum well optical modulation layer 5. Further, in order to exhibit the effect without excessively increasing the minigap, the thickness of about 2 to 6 atomic layers is desirable. Furthermore, for a margin with respect to the critical film thickness, a thickness of 2 to 4 atomic layers is more desirable at which crystal dislocation due to the degree of lattice mismatch of each layer is unlikely to occur and the minigap does not affect the level of the heavy holes. Furthermore, a thickness of two atomic layers, which is the minimum thickness at which dislocation multiplication does not occur during long-term operation and the minigap occurs is most desirable because it has the greatest margin with respect to the critical film thickness.

On the premise of the above-described configuration, characteristics of the semiconductor optical modulator 1 (Example 1) of the present application and characteristics of a semiconductor optical modulator according to the comparative example in which a quantum well layer is formed of the random alloy will be described with reference to a band diagram of the quantum well layer and the wavelength dependence of an optical absorption coefficient α and a refractive index change amount Δn.

A quantum level ΔEn measured from the band bottom is approximately represented by Formula (1).

ΔEn≈((h·h))/(2m*))·((π·n)/Lz) (1)

where h is Planck's constant, m* is an effective mass of a hole or an electron, n is a positive integer corresponding to a level, and Lz is an effective quantum well width.

As shown in FIG. 3A, in the valance band in the quantum well layer 51R formed of the random alloy in the semiconductor optical modulator according to the comparative example, a quantum level (solid line) of the holes having a large effective mass m* and a quantum level (broken line) of the holes having a small effective mass m* are formed. Since each hole is attracted to the electron by Coulomb force to form an exciton, the actual quantum level ΔEn is slightly smaller than the value calculated from Formula (1).

On the other hand, in the semiconductor optical modulator 1 according to Example 1 in which the digital alloy layer is used as the quantum well layer 51, the minigap occurs in the quantum well layer 51 as shown in FIG. 2A, and thus the quantum level of the light holes is not formed or is weakened. As a result, in the comparative example, as shown in FIG. 3B, two absorption peaks due to the excitons appear in the wavelength dependence of the optical absorption coefficient α, whereas in Example 1, as shown in FIG. 2B, one absorbance peak appears, or even if there are two peaks, the peak due to the light holes becomes small. In the figure, αₙᵥ represents the optical absorption coefficient when no voltage is applied, and αₐᵥ represents the optical absorption coefficient when a voltage is applied. As a result, the wavelength half-width of the exciton absorption becomes narrow.

In the EA modulator, light having a wavelength longer than the absorption peak wavelength of the excitons is made incident to perform the modulation. When a voltage is applied to the quantum well layer, the absorption peak due to the excitons shifts to a long wavelength side due to the quantum-confined Stark effect described in the background art, and the incident light is absorbed. Therefore, when the wavelength half-width of the exciton absorption is narrow as in the amount of change in the optical absorption coefficient α (absorption coefficient change amount Δα) shown in FIG. 2B, the absorption coefficient change amount Δα without voltage application is larger than that in the comparative example (FIG. 3B). As a result, even if the voltage applied to the EA modulator is low, a sufficient change in the optical absorption coefficient α can be obtained. In addition, since the wavelength half-width of the exciton absorption is narrow, the optical absorption in a state where no voltage is applied is small as indicated by a loss L_{EA} shown in FIG. 2B.

In the MZ modulator, light having a wavelength longer than that of the EA modulator is made incident, and the optical modulation layer is formed such that the phase of the light is modulated without absorbing the light so much. The phase of the light changes because a change in the refractive index (refractive index change amount Δn) occurs due to the Kramers-Kronig relation in accordance with a change in the absorption spectrum of the light, and thus the refractive index change amount Δn increases as the absorption coefficient change amount Δα increases. Broken lines in FIG. 2B and FIG. 3B show curves of the refractive index change amount Δn. Since the absorption coefficient change amount Δα is larger in Example 1 (FIG. 2B) than in the comparative example (FIG. 3B), so that the refractive index change amount Δn is also larger. Thus, a sufficient refractive index change amount Δn can be obtained even when the voltage applied to the MZ modulators is low. In addition, since the wavelength half-width of the exciton absorption is narrow, the optical absorption in a state where a voltage is not applied is reduced as in a loss L_{MZ} shown in FIG. 2B. This is also applicable to a phase modulator other than the MZ modulator.

That is, in the digital alloy, the minigap is formed in the valence band or the conduction band, and the quantum level is limited. By using the digital alloy instead of a normal random alloy for the quantum well layer 51, the level width of the excitons formed in the quantum well layer 51 is limited, and the wavelength half-width of the exciton absorption becomes narrow. Further, in the quantum well layer 51R (comparative example) formed of the random alloy, in addition to the exciton absorption due to the heavy holes, the exciton absorption due to the light holes occurs, and the wavelength spectrum of the exciton absorption has two peaks, and the wavelength half-width of the exciton absorption becomes wide, while in the digital alloy (Example), it is possible to narrow the wavelength half-width by the one peak.

As described above, the digital alloy used in the semiconductor optical modulator 1 of the present application exhibits different characteristics from the random alloy due to the occurrence of the minigap, and the definition thereof will be described using ternary InAlAs, which is easy to describe it as a specific example. Ordinary InAlAs has AlIn randomly arranged while maintaining a constant composition ratio in aluminum (Al), indium (In), and arsenic (As), and thus it is called bulk, random alloy, or the like. On the other hand, the digital alloy (refer to, for example, Digital Alloy: JOURNAL OF LIGHTWAVE TECHNOLOGY, (USA), 2018, VOL. 36, NO. 17, pp. 3580-3585) is formed by alternately stacking binary AlAs and InAs with a thickness of several atomic layers (2 to 6 atomic layers) to form InAlAs.

That is, the digital alloy is obtained by alternately stacking a plurality of semiconductors having different constituent elements or composition ratios with a layer thickness of several atomic layers, and the digital alloy is also the same as those referred to as a “pseudoalloy (for example, refer to the specification of U.S. Pat. No. 6,326,650)”, an “ultrashort period superlattice”, or the like. Although there is a typical multiple quantum well layer or superlattice as a similar structure, they are essentially different from the digital alloy because elements are arranged at random while maintaining a constant composition ratio in each layer.

Unlike a typical multiple quantum well layer or a superlattice, the digital alloy is a stack of several atomic layers each, so that the property in each layer of AlAs and InAs is not exhibited, and the digital alloy has a band structure close to bulk InAlAs having an averaged composition ratio. However, the digital alloy has a feature that the minigap is formed in the valence band or the conduction band because elements are regularly stacked and periodicity of atoms is present, which are not exhibited in the random alloy. In other words, the digital alloy has an epi-layer structure in which materials are selected for the minigap to occur, and the stacking period is designed and adjusted in units of several atomic layers, and the layers are alternately stacked. The semiconductor optical modulator 1 of the present application is characterized by using the minigap unique to the digital alloy.

The digital alloy is not limited to the stacking of binary AlAs and InAs etc., as described above, but may also be stacking of binary InAs and GaAs. In addition to InAlGaAs in which ternary InAlAs, InGaAs, and the like are alternately stacked in several atomic layers, InAlGaAs and the like in which quaternary InAl_{z}Ga_{(1-z)} As, InAlₓGa₍₁₋ₓ₎ As, and the like shown in Embodiment 1 are alternately stacked in several atomic layers are possible. Further, InAlGaAs in which binary AlAs and ternary InAl_{z}Ga_{(1-z)}As are stacked, and stacking of ternary In_{z}Ga_{(1-z)}As and quaternary InAlₓGa₍₁₋ₓ₎As are also possible.

Furthermore, InGaAs in which binary GaAs, InAs, or the like and ternary In_{z}Ga_{(1-z)}As are stacked, and stacking of binary InAs, GaAs, or AlAs and quaternary InAlₓGa₍₁₋ₓ₎As are also possible. Here, it is also possible to replace Al of the above-described materials with phosphorus (P), and it is also possible to use a material system (InAlAsSb) to which antimony (Sb) is added. Furthermore, it is possible to select a combination of materials such that the minigap to be described later occurs, such combination as quintet InAlGaAsP in which quaternary InAlGaAs and InGaAsP are stacked. Here, although there is a concern about a problem of crystal strain, since each layer has a thickness of several atomic layers, even when the degree of lattice mismatch in each layer is plus/minus several percentages, crystal growth is possible as long as the degree of integrated lattice mismatch is small.

As described above, in the semiconductor optical modulator 1 according to Embodiment 1, the digital alloy structure is applied to the quantum well layer 51, that is, the structure in which the stacking period is set in units of several atomic layers is applied to it in order for the minigap to occur, thereby suppressing the absorption due to the light holes. As a result, as compared with a typical EA modulator or MZ modulator using the random alloy, the operating voltage can be reduced, and the propagation loss of light can also be reduced.

The distinction from the digital alloy defined in the present application and the difference in characteristics will be additionally described. For example, Patent Document 1 discloses an idea in which a quantum well layer is formed by alternately stacking one atomic layer each for InAs and GaAs to reduce the energy fluctuation of the excitons. However, in the quantum well layer in which one atomic layer is alternately stacked, the band structure is substantially the same as that of the random alloy, and the minigap as in the digital alloy of the present application does not appear.

The width of the minigap increases when the thickness (number of atoms) of each layer is in the range of 2 atoms to 8 atoms. If the minigap does not appear, the exciton absorption due to the light holes is not suppressed, so that the wavelength spectrum has two peaks and the wavelength half-width of the exciton absorption cannot be narrowed. That is, in the case where the thickness of each layer is one atom, it is different from the digital alloy defined in the present application.

In addition, a structure example of a single quantum well that is configured by an arrangement of short-period superlattice and in which a quantum confinement potential thereof is an equivalent quadratic curve is disclosed (for example, refer to Japanese Patent Application Laid-Open No. H04-250428). However, in such a structure in which the potential gradually changes, the minigap having a constant energy level as in the digital alloy of the present application does not appear.

In order for the minigap to appear, the total thickness of the stacked layers repeated at the same period needs to be several nanometers, and the period needs to be changed stepwise without being gradually changed. If the minigap does not appear, the exciton absorption due to the light holes is not suppressed, so that the wavelength spectrum has two peaks, and the wavelength half-width of the exciton absorption cannot be narrowed.

Also a basic unit quantum well is disclosed in which a pair of quantum barrier layers formed of an Al_{0.3}Ga_{0.7}As layer having a thickness of three atomic layers are provided on both sides of an individual rectangular potential quantum well formed of a GaAs layer having a thickness of 38 atomic layers (for example, refer to Japanese Patent Application Laid-Open No. H07-261133). However, the layers with a thickness of three atomic layers are only on both sides, and are not a repeating structure. Therefore, unlike the digital alloy of the present application, the minigap does not appear, and the exciton absorption due to the light holes is not suppressed.

Furthermore, a structure in which the amount of strain is gradually changed in the well layer can be considered, but also in this case, similarly to the structure in which the potential is gradually changed, the structure is different from the digital alloy of the present application in that the structure is not a periodically repeated and thus the minigap does not appear.

### Embodiment 2

In Embodiment 1, the example in which all the quantum well layers are formed of only the digital alloy has been described. In Embodiment 2, an example in which each of the quantum well layers is formed of two layers including the digital alloy layer and the random alloy layer will be described.

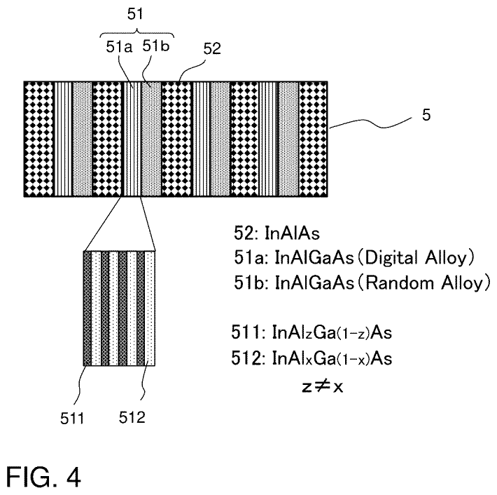

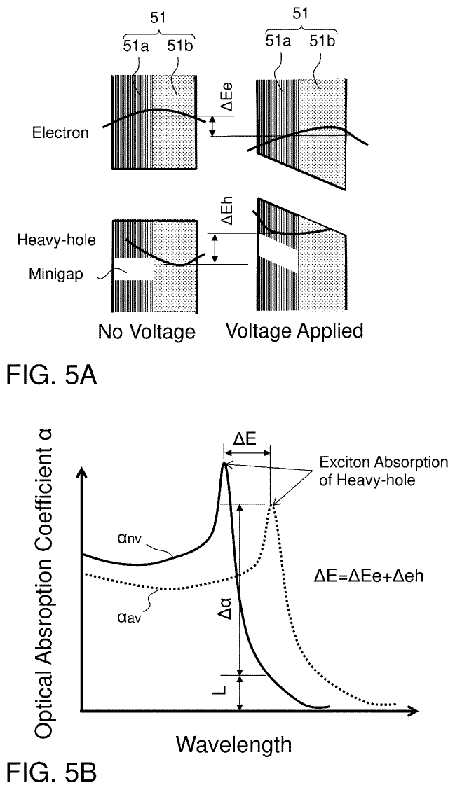

FIG. 4, FIG. 5A, and FIG. 5B are for describing a configuration of a semiconductor optical modulator according to Embodiment 2, and FIG. 4 is an enlarged cross-sectional view of a part of a multiple quantum well optical modulation layer among layers constituting the semiconductor optical modulator. FIG. 5A shows a band diagram of a quantum well layer constituting the multiple quantum well optical modulation layer in the case where no voltage is applied and in the case where a voltage is applied, and FIG. 5B is a diagram in the form of a line graph showing wavelength dependence of the optical absorption coefficient. Note that the same portions as those in Embodiment 1 are denoted by the same reference numerals, and the description thereof will be omitted.

An EA modulator 1 according to Embodiment 2 has substantially the same structure (FIG. 1A) as the EA modulator 1 described in Embodiment 1, except for the structure of the multiple quantum optical modulation layer 5 that absorbs light. In the semiconductor optical modulator 1 according to Embodiment 2, as shown in FIG. 4, the quantum well layer 51 is not formed entirely of the digital alloy but has a two-layer structure including a digital alloy layer 51a and a random alloy layer 51b.

The digital alloy layer 51a is formed by alternately growing the first composition layer 511 made of i-type InAl_{z}Ga_{(1-z)}As with the composition ratio z and a thickness of two atomic layers, and the second composition layer 512 made of i-type InAlₓGa₍₁₋ₓ₎As with a the composition ratio x and a thickness of two atomic layers, and thus is about half as thick as the well layer (about 2 to 7 nm). Then, for the remaining thickness, a typical InAl_{y}Ga_{(1-y)} random alloy is formed. The composition ratio z and the composition ratio x are different from each other, and the average composition ratio (=(z+x)/2) of the digital alloy layer 51a is set to be substantially the same as that of the random alloy layer 51b (InAl_{y}Ga_{(1-y)}). That is, (z+x)/2≈y.

As in Embodiment 1, each of the barrier layers 52 has a thickness of several nanometers and is formed of i-type InAlAs or InAlGaAs having a band gap larger than that of InAlGaAs having the average composition ratio of the quantum well layer 51. The total thickness of the multiple quantum well optical modulation layer 5 is about 0.1 μm. The width and composition of the quantum well layer 51 are set such that the optical absorption edge is at a wavelength shorter than the wavelength of the light to be modulated by about several nanometers to several tens of nanometers.

Although the multiple quantum well optical modulation layer 5 is described as the i-type also in Embodiment 2, the multiple quantum well optical modulation layer 5 may be a p-type or an n-type as long as the carrier concentration is low and an electric field is applied to even a part of the multiple quantum well optical modulation layer 5. Each of the layers (the first composition layer 511 and the second composition layer 512) in the digital alloy layer 51a is two-atomic layers, but may be about two to eight atomic layers thick.

Further, in order to exhibit the effect without excessively increasing the minigap, the thickness of about 2 to 6 atomic layers is desirable. Furthermore, for a margin with respect to the critical film thickness, a thickness of 2 to 4 atomic layers is more desirable at which crystal dislocation due to the degree of lattice mismatch of each layer is unlikely to occur and the minigap does not affect the level of the heavy holes. Furthermore, a thickness of two atomic layers, which is the minimum thickness at which dislocation multiplication does not occur during long-term operation and the minigap occurs is most desirable because it has the greatest margin with respect to the critical film thickness.

As shown in FIG. 5A, even in the semiconductor optical modulator 1 (Example 2) using the two-layer structure of the digital alloy layer 51a and the random alloy layer 51b in the quantum well layer 51 as in Embodiment 2, the mini-gap appears in the quantum well layer 51. Therefore, the quantum level of the light holes is not formed or is weakened.

In addition, the level of the heavy holes is biased toward the random alloy layer 51b in the quantum well layer 51 in the case of no voltage in the band diagram. When a voltage is applied such that the side of the digital alloy layer 51a is negative, the level of the heavy holes is biased toward the digital alloy layer 51a in the case with a voltage in the band diagram. Since the portion of the digital alloy layer 51a has the minigap, the energy level shifts upward (toward the conductive band) as compared with the comparative example (FIG. 3B). That is, an energy shift amount ΔEh of the heavy holes due to the voltage application is larger than that of the comparative example.

On the other hand, an energy shift amount ΔEe of the electron by the voltage application does not change. As a result, as shown in FIG. 5B, in the wavelength dependence of the optical absorption coefficient α, a shift amount ΔE (=ΔEh+ΔEe) of the peak wavelengths of the exciton absorption due to the heavy holes is larger than that of the comparative example.

In the EA modulator, light having a wavelength longer than the absorption peak wavelength of the excitons is made incident to perform the modulation. When a voltage is applied to the quantum well layer, the absorption peak of the excitons shifts to a long wavelength side due to the quantum-confined Stark effect described in the background art, and the incident light is absorbed. When the shift amount ΔE of the peak wavelengths of the exciton absorption is large, the absorption coefficient change amount Δα becomes large. As a result, even if a voltage applied to the EA modulator is low, a sufficient change in the absorption coefficient can be obtained. In addition, when the shift amount ΔE of the peak wavelengths of the exciton absorption is large, the wavelength of the light incident on the EA modulator can be set to be longer than before, and therefore, the optical absorption in a state in which a voltage is not applied becomes small as indicated by a loss L shown in FIG. 5B.

In the MZ modulator, light having a wavelength longer than that of the EA modulator is made incident, and the phase of the light is modulated without absorbing the light so much. The phase of the light changes because the refractive index change amount Δn occurs due to the Kramers-Kronig relation in accordance with a change in the absorption spectrum of the light, and thus the refractive index change amount Δn increases as the absorption coefficient change amount Δα increases. Since the absorption coefficient change amount Δα is larger in Example 2 (FIG. 5B) than in the comparative example (FIG. 3B), the refractive index change amount Δn is also larger, and a sufficient refractive index change amount Δn can be obtained even with a lower applied voltage to the MZ modulator. In addition, similarly to the EA modulator, when the shift amount ΔE of the peak wavelengths of the exciton absorption is large, the wavelength of the light made incident on the MZ modulator can be set to be longer than that of the comparative example, resulting in smaller optical absorption in a state in which the voltage is not applied.

As described above, as compared with the EA modulator or the MZ modulator according to the comparative example in which the quantum well layer 51R is formed of only the random alloy, or as compared with Embodiment 1 in which all the quantum well layer 51 is formed of the digital alloy, in Example 2, the operation voltage can be reduced and the propagation loss of light can also be reduced by the above-described effect. Further, in the epitaxial growth of the digital alloy, it is necessary to open and close the shutter of the epitaxial apparatus and switch the gas every several atomic layers, and therefore, the epitaxial growth time becomes long. However, since only a part of the quantum well layer 51 is formed as the digital alloy layer 51a in Embodiment 2, it is possible to significantly reduce the epitaxial growth time as compared with Embodiment 1 in which the entire quantum well layer 51 is formed of the digital alloy. Furthermore, the wear and tear of the epitaxial growth apparatus can be suppressed.

### Embodiment 3

In Embodiment 1 or Embodiment 2, examples in which the first composition layer and the second composition layer in the digital alloy layer are stacked with the same repeat thickness has been described. In Embodiment 3, an example in which a quantum well layer is formed of two types of digital alloy layers with different repeat thicknesses will be described.

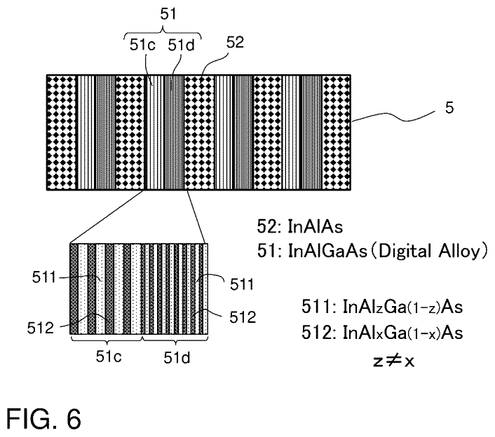

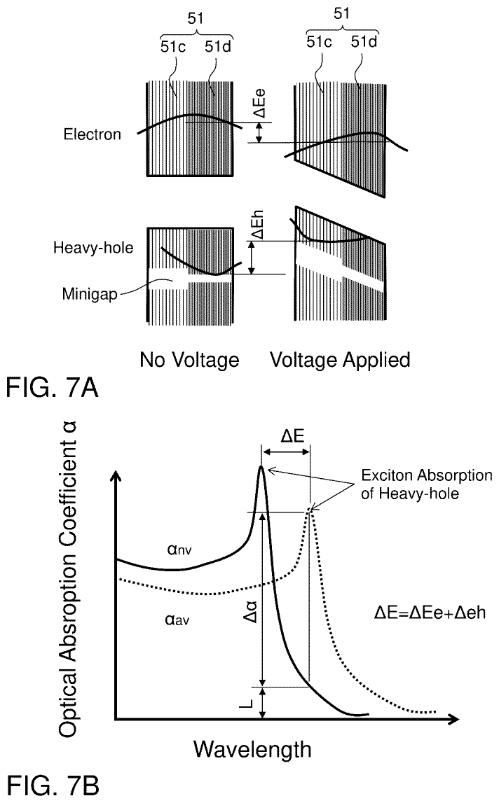

FIG. 6, FIG. 7A, and FIG. 7B are for describing a configuration of an optical modulator according to Embodiment 3, and FIG. 6 is an enlarged cross-sectional view of a part of a multiple quantum well optical modulation layer. FIG. 7A is a band diagram of the quantum well layer constituting the multiple quantum well optical modulation layer in the case where no voltage is applied and in the case where a voltage is applied, and FIG. 7B is a diagram in the form of a line graph showing wavelength dependence of the optical absorption coefficient. Note that the same portions as those in Embodiment 1 are denoted by the same reference numerals, and the description thereof will be omitted.

A semiconductor optical modulator 1 as the EA modulator according to Embodiment 3 is substantially the same as the structure of the semiconductor optical modulator 1 described in Embodiment 1 (FIG. 1A), but the structure of the multiple quantum well optical modulation layer 5 for absorbing light is different. In the semiconductor optical modulator 1 according to Embodiment 3, as shown in FIG. 6, the entire quantum well layer 51 is formed of the digital alloy, but it has the two-layer structure with a long-period layer 51c having a long period and a short-period layer 51d having a short period as the repeat thickness.

The long-period layer 51c is made to have an eight atomic period (repeat thicknesses) by alternately growing the first composition layer 511 made of i-type InAl_{z}Ga_{(1-z)}As with the composition ratio z and a thickness of four atomic layers, and the second composition layer 512 made of i-type InAlₓGa₍₁₋ₓ₎As with the composition ratio x and a thickness of four atomic layers. The short-period layer 51d is made to have a four atomic period (repeat thicknesses) by alternately growing the first composition layer 511 made of i-type InAl_{z}Ga_{(1-z)}As with the composition ratio z and a thickness of two atomic layers, and the second composition layer 512 made of i-type InAlₓGa₍₁₋ₓ₎As with the composition ratio x and a thickness of two atomic layers. The long-period layer 51c having the eight atomic period is about half as thick as the well layer (about 2 to 7 nm), and the short-period layer 51d having the four atomic period constitutes the remaining portion.

The composition ratio z of the first composition layer 511 and the composition ratio x of the second composition layer 512 are different from each other, and the average composition ratio (=(z+x)/2) of the digital alloy is set to be substantially the same as that of the quantum well layer formed of the random alloy.

Each of the barrier layers 52 has a thickness of several nanometers and is formed of i-type InAlAs or InAlGaAs having a band gap larger than that of InAlGaAs having the average composition ratio of the quantum well layer 51, as in Embodiment 1. The total thickness of the multiple quantum well optical modulation layer 5 is about 0.1 μm. The width and composition of the quantum well layer 51 are set such that the optical absorption edge is at a wavelength shorter than the wavelength of the light to be modulated by about several nanometers to several tens of nanometers.

Although the multiple quantum well optical modulation layer 5 is described as the i-type in Embodiment 3, the multiple quantum well optical modulation layer 5 may be p-type or n-type as long as the carrier concentration is low and an electric field is applied to even a part of the multiple quantum well optical modulation layer 5. In addition, each layer (the first composition layer 511 and the second composition layer 512) in the long-period layer 51c and the short-period layer 51d is two atomic layers and four atomic layers, respectively, but a combination may be selected within a range of thicknesses of about two to eight atomic layers. Further, in order to exhibit more effect, it is desirable to divide the thickness in a thickness range of about 2 to 6 atomic layers, and it is more desirable to divide the thickness in a thickness range of 2 to 4 atomic layers.

The repeat thicknesses of the each layer in the long-period layer 51c and the short-period layer 51d may be gradually changed to a two-atomic layer period, a four-atomic layer period, a six-atomic layer period, or the like within the quantum well layer 51. However, since it is necessary to form the minigap, the repeat thickness to be at least 1 to 2 nm in total is needed. Furthermore, in order to reliably form the minigap, a repetitive structure having the same period needs to have a thickness of about several nanometers, and the period needs to be changed stepwise.

In Embodiment 3, the minigap also appears in the quantum well layer 51 as shown in FIG. 7A even in the semiconductor optical modulator 1 (Example 3) using the two-layer structure by the long-period layer 51c and the short-period layer 51d of the digital alloy in the quantum well layer 51. Therefore, the quantum level of the light holes is not formed or is weakened.

In addition, the width of the minigap increases as the repetition period of the digital alloy increases. In the quantum well layer 51, the width of the minigap is narrower in a portion with the short period (short-period layer 51d) than in a portion with the long period (long-period layer 51c).

Further, the level of the heavy holes is biased toward the short-period layer 51d in the case of no voltage in the band diagram. When a voltage is applied such that the side of the long-period layer 51c is negative, the level of the heavy holes is biased toward the long-period layer 51c in the case with a voltage in the band diagram. When the period is longer, the minigap is wider, so that the energy level shifts upward (to the conduction band side) as compared with the comparative example (FIG. 3B). That is, the energy shift amount ΔEh of the heavy holes due to the voltage application is larger than that of the comparative example.

As a result, as shown in FIG. 7B, in the wavelength dependence of the optical absorption coefficient α, the shift amount ΔE of the peak wavelengths of the exciton absorption due to the heavy holes becomes large.

In the EA modulator, light having a wavelength longer than the absorption peak wavelength of the excitons is made incident to perform the modulation. When a voltage is applied to the quantum well layer, the absorption peak of the excitons shifts to a long wavelength side due to the quantum-confined Stark effect described in the background art, and the incident light is absorbed. When the shift amount ΔE of the peak wavelengths of the exciton absorption is large, the absorption coefficient change amount Δα becomes large. As a result, even if a voltage applied to the EA modulator is low, a sufficient change in the absorption coefficient can be obtained. In addition, when the shift amount ΔE of the peak wavelengths of the exciton absorption is large, the wavelength of the light incident on the EA modulator can be set to be longer than before, and therefore, the optical absorption in a state in which a voltage is not applied becomes small as indicated by the loss L shown in FIG. 7B.

In the MZ modulator, light having a wavelength longer than that of the EA modulator is made incident, and the phase of the light is modulated without absorbing the light so much. The phase of the light changes because the refractive index change amount Δn occurs due to the Kramers-Kronig relation in accordance with a change in the absorption spectrum of the light, and thus the refractive index change amount Δn increases as the absorption coefficient change amount Δα increases. Since the absorption coefficient change amount Δα is larger in Example 3 (FIG. 7B) than in the comparative example (FIG. 3B), the refractive index change amount Δn is also larger, and a sufficient refractive index change amount Δn can be obtained even with a lower applied voltage to the MZ modulator. In addition, similarly to the EA modulator, when the shift amount ΔE of the peak wavelengths of the exciton absorption is large, the wavelength of the light made incident on the MZ modulator can be set to be longer than that of the comparative example, resulting in smaller optical absorption in a state in which the voltage is not applied.

As described above, as compared with the EA modulator or the MZ modulator according to the comparative example in which the quantum well layer 51R is formed of only the random alloy, in Example 3, the operation voltage can be reduced and the propagation loss of light can also be reduced by the above-described effect. Further, as compared with the EA modulator or the MZ modulator according to Example 1 in which the quantum well layer 51 is formed of the digital alloy with a uniform repetition period of each atomic layer in the quantum well layer, the EA modulator or the MZ modulator according to Embodiment 3 can reduce the operating voltage and the propagation loss of light by the above-described effect.

In the digital alloy, the energy level of the minigap varies depending on the repetition period of each atomic layer. In the epitaxial growth of the digital alloy, it is necessary to alternately stack the layers by accurately switching the constituent element and the composition ratio at a repetition period of every several atomic layers, but in practice, unevenness or variation occurs in the switching of the constituent element or the composition ratio. When unevenness or variation occurs, the energy level of the minigap does not appear as intended, and may not coincide with the energy level of the light holes.

However, in Embodiment 3, since the repetition period is changed within the quantum well layer 51, the energy level of the minigap of any one of the repetition periods coincides with the energy level of the light holes, and the absorption due to the light holes can be suppressed. Therefore, the variation in the absorption spectrum can be reduced. Therefore, the characteristics are stabilized, the yield is improved, and the productivity is improved.

### Embodiment 4

In Embodiment 1 to Embodiment 3, the examples in which the multiple quantum well optical modulation layer is formed by the barrier layer of the random alloy and the quantum well layer using the digital alloy has been described. In Embodiment 4, an example in which the digital alloy is applied to the barrier layer will be described.

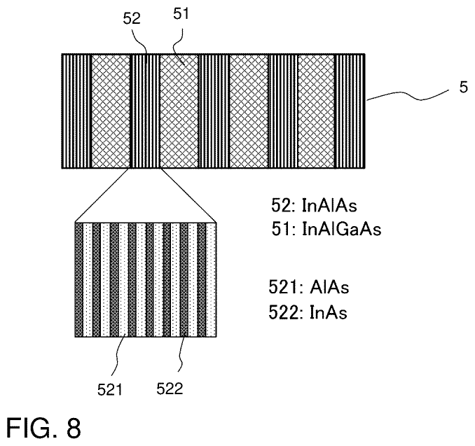

FIG. 8 is a diagram for describing a configuration of a semiconductor optical modulator according to Embodiment 4, and is an enlarged cross-sectional view of a part of a multiple quantum well optical modulation layer among layers constituting the semiconductor optical modulator. Note that the same portions as those in Embodiment 1 are denoted by the same reference numerals, and the description thereof will be omitted.

A semiconductor optical modulator 1 as an EA modulator according to Embodiment 4 is substantially the same as the structure of the semiconductor optical modulator 1 described in Embodiment 1 (FIG. 1A), but the structure of the multiple quantum well optical modulation layer 5 for absorbing light is different. In the semiconductor optical modulator 1 according to Embodiment 4, as shown in FIG. 8, the quantum well layer 51 may be formed of InAlGaAs of the digital alloy or InAlGaAs of the random alloy, but the barrier layer 52 is formed of the digital alloy.

The barrier layer 52 is i-type InAlAs or InAlGaAs having a band gap larger than that of InAlGaAs of the quantum well layer 51. As shown in FIG. 8, in the case of the digital alloy of InAlAs, a first composition layer 521 of i-type AlAs having a layer thickness of two atomic layers and a second composition layer 522 of i-type InAs having a layer thickness of two atomic layers are alternately stacked.

In the case of the digital alloy of InAlGaAs, it is formed by alternately growing the first composition layer 521 made of i-type InAl_{z}Ga_{(1-z)}As with the composition ratio z and a thickness of two atomic layers, and the second composition layer 522 made of i-type InAlₓGa₍₁₋ₓ₎As with the composition ratio x and a thickness of two atomic layers. The composition ratio z and the composition ratio x are different from each other, and the band gap in the case where the random alloy is formed at an average composition ratio (=(z+x)/2) as the digital alloy is set to be larger than the band gap of the quantum well layer 51.

The total thickness of the multiple quantum well optical modulation layer 5 is about 0.1 μm. The width and composition of the quantum well layer 51 are set such that the optical absorption edge is at a wavelength shorter than the wavelength of the light to be modulated by about several nanometers to several tens of nanometers. Note that, although the multiple quantum well optical modulation layer 5 is described as the i-type in Embodiment 4, the multiple quantum well optical modulation layer 5 may be p-type or n-type as long as an electric field is applied to even a part of the multiple quantum well optical modulation layer 5. In addition, each of the layers (the first composition layer 521 and the second composition layer 522) of the digital alloy in the barrier layer 52 is two atomic layers, but may be about two to eight atomic layers thick.

Further, in order to exhibit the effect without excessively increasing the minigap, the thickness of about 2 to 6 atomic layers is desirable. Furthermore, for a margin with respect to the critical film thickness, a thickness of 2 to 4 atomic layers is more desirable at which crystal dislocation due to the degree of lattice mismatch of each layer is unlikely to occur and the minigap does not affect the level of the heavy holes. Furthermore, a thickness of two atomic layers, which is the minimum thickness at which dislocation multiplication does not occur during long-term operation and the minigap occurs is most desirable because it has the greatest margin with respect to the critical film thickness.

In the EA modulators or the like, when a dopant such as Zn or S existing in a high concentration in the InGaAs contact layer or the InP substrate 2 diffuses into the multiple quantum well layer, the multiple quantum well layer becomes p-type or n-type. In this case, even when a voltage is applied, an electric field is not applied to each quantum well layer or is weakened. Since the operating voltage increases when the electric field is not applied, it is important to prevent diffusion of the dopant into the multiple quantum well layer.

Since the InAs and the AlAs shown in FIG. 8 are not intrinsically lattice-matched to the InP substrate, the compressive strain and the tensile strain are repeated at a period of several atomic layers, but the total strain amount is offset and the crystal growth is possible. However, since the lattice constant of InAs is different from that of AlAs by 6% or more, a large crystal strain is locally applied to each layer. Since a dopant such as Zn has a property of being less likely to be diffused into a layer having a large strain, the diffusion can be prevented by using the digital alloy for the barrier layer 52. In addition, the digital alloy may also be applied to layers such as the optical confinement layer (n-type optical confinement layer 4, p-type optical confinement layer 6) and cladding layers (n-type cladding layer 3, p-type cladding layer 7), which are closer to the multiple quantum well optical modulation layer 5 than to the InGaAs contact layer or the InP substrate 2 where dopants such as zinc and sulfur exist in high concentration among the semiconductor layers, and the same effect can be obtained.

Note that an example in which a superlattice layer is applied to the barrier layer is disclosed (for example, refer to Japanese Patent Application Laid-Open No. H04-088322). In this case, a different band gap appears in each of the superlattice layers. On the other hand, in the semiconductor optical modulator 1 according to Embodiment 4, the barrier layer 52 is formed of the digital alloy in which very thin layers of several atomic layers are stacked. Therefore, since the band gap of each layer does not appear, the band structure is different from the example in which the superlattice layer is applied to the barrier layer 52, and since it is possible to alternately stack layers having a large strain in which the difference in lattice constant is several percentages, the effect of preventing the diffusion of the dopants is large.

In addition, when the minigap is present as in the digital alloy used in the semiconductor optical modulator 1 of the present application, the effect of confining the electrons or the holes is increased, and there is also an effect of narrowing the half-width of the exciton absorption. Further, as in the quantum well layer of Embodiment 3, when the repetition period of each atomic layer of the digital alloy is changed within the barrier layer 52, a plurality of minigaps are formed in accordance with the repetition period. Therefore, the effect of confining the electrons or the holes is increased, and the effect of narrowing the half-width of the exciton absorption is increased.

As described above, in the semiconductor optical modulator 1 according to Embodiment 4, the dopant diffusion is suppressed and the operating voltage can be reduced as compared with the typical EA modulator or MZ modulator as shown in the comparative example. Since the barrier layer 52 is designed to have the digital alloy structure in which the minigap is caused to appear by adjusting the stacking period in units of several atomic layers to suppress the absorption by the light holes, the effective barrier layer height (=energy barrier height) is increased by the effect of the minigap. As a result, since the exciton confinement effect increases, the half-width of the exciton does not increase even when the operating temperature is increased, an increase in light absorption loss at a high temperature and an increase in operating voltage are suppressed, and the temperature range in which the EA modulator and the MZ modulator can operate is expanded.

Note that, in the embodiments of the present application, the case where the multiple quantum well layer in which the plurality of quantum well layers are stacked is used as the optical modulation layer has been described. In addition, even in a case where a single quantum well layer in which the number of quantum well layers is one is used as the optical modulation layer, it is obvious that the same effect as in Embodiment 1 to Embodiment 4 is obtained, and the case is included in the technical scope of the present application.

In addition, in each of the embodiments of the present application, the quantum well layer that is made of the digital alloy with the thickness of about several nanometers to 20 nm and is interposed between the barrier layers is used as the optical modulation layer. However, a semiconducting layer that is made of the digital alloy with a thickness of about 20 to 500 nm and does not form the quantum well may be used as the optical modulation layer.

In the case of a typical random alloy semiconducting layer, when the wavelength dependence of the optical absorption coefficient is measured, there is a boundary at the optical absorption edge wavelength corresponding to the band gap energy, and the optical absorption coefficient increases when the wavelength becomes shorter than the boundary. On the other hand, in the case of the digital alloy, as described in Example 1, the minigap appears in the valence band, and the absorption coefficient at a wavelength corresponding to the energy level of the minigap decreases. Instead, the optical absorption coefficient in the vicinity of the optical absorption edge increases, which is apparent from the sum rule that the sum of the absorption coefficients is constant.

As a result, when the wavelength is shorter than the absorption edge wavelength, the optical absorption coefficient in the digital alloy is sharply increased as compared with that in the random alloy. Therefore, even in the case where the optical modulation layer is not the quantum well layer but the semiconductor layer having the thickness of about 20 to 500 nm, the effect of reducing the operating voltage and the propagation loss can be obtained as in Embodiment 1 to Embodiment 4. In addition, it is not the quantum well layer, and thus an effect of easy manufacturing is brought about, and this case is included in the technical scope of the present application.

Alternatively, the optical modulation layer may be a single quantum well layer formed of a well layer and barrier layers in contact with the well layer. The well layer may be made of the digital alloy and is about 20 to 500 nm thick. Also in this case, there are the above-described effects of reducing the operating voltage and the propagation loss, and the effect that the number of quantum well layers is small and the manufacturing is easy is exhibited, and this case is included in the technical scope of the present application.

Although various exemplary embodiments are described in the present application, various features, aspects, and functions described in one or more embodiments are not inherent in an application of the contents disclosed in a particular embodiment, and can be applicable alone or in their various combinations to each embodiment. Accordingly, countless variations that are not illustrated are envisaged within the scope of the art disclosed in the specification of the present application. For example, the case where at least one component is modified, added or omitted, and the case where at least one component is extracted and combined with a component disclosed in another embodiment are included.

As described above, according to the semiconductor optical modulator 1 of the present application, the semiconductor optical modulator 1 is formed by stacking a plurality of semiconductor layers including an optical modulation layer (for example, the multiple quantum well optical modulation layer 5) on the semiconductor substrate (InP substrate 2) and emits light by modulating an intensity or a phase of the light incident on the optical modulation layer (for example, the multiple quantum well optical modulation layer 5). The optical modulation layer (for example, the multiple quantum well optical modulation layer 5) is formed using the digital alloy in which the semiconductor layers having a layer thickness of two or more atomic layers and having different constituent elements or composition ratios are alternately and repeatedly stacked. Therefore, since the wavelength half-width of the exciton absorption can be narrowed, it is possible to obtain the semiconductor optical modulator 1 in which the change in the absorption coefficient or the refractive index is increased and the propagation loss of light is reduced.

Here, when the semiconductor optical modulator 1 is the electro-absorption type or the Mach-Zehnder type, the semiconductor optical modulator 1 with stability and high reliability can be obtained.

The optical modulation layer is formed by alternately stacking the quantum well layer 51 and the barrier layer 52 having a band gap larger than that of the quantum well layer 51 (the multiple quantum well optical modulation layer 5), and at least one of the quantum well layer 51 and the barrier layer 52 is formed using the digital alloy described above. Therefore, the wavelength half-width of the exciton absorption can be reliably narrowed, and thus it is possible to obtain the semiconductor optical modulator 1 in which the change in the absorption coefficient or the refractive index is increased and the propagation loss of light is reduced.

In this case, when the quantum well layer 51 is formed by stacking the digital alloy (the digital alloy layer 51a) and the random alloy (the random alloy layer 51b), the epitaxial growth time can be significantly reduced and the wear and tear of the epitaxial growth apparatus can be suppressed as compared with the case where the quantum well layer 51 is entirely formed of the digital alloy.

The optical modulation layer may be formed of the single quantum well layer including the quantum well layer and the barrier layer, the quantum well layer being formed of the digital alloy having a thickness of 20 nm or more and 500 nm or less, the barrier layer being in contact with the quantum well layer and having a larger band gap than the quantum well layer. In this case, the wavelength half-width of the exciton absorption can be reliably narrowed, and thus it is possible to obtain the semiconductor optical modulator 1 in which the change in the absorption coefficient or the refractive index is increased and the propagation loss of light is reduced.

Even when the barrier layer 52 is formed of the digital alloy, the wavelength half-width of the exciton absorption can be narrowed, and thus it is possible to obtain the semiconductor optical modulator 1 in which the change in the absorption coefficient or the refractive index is increased and the propagation loss of light is reduced.

Alternatively, even when the optical modulation layer is formed of the digital alloy having a thickness of 20 nm or more and 500 nm or less, the wavelength half-width of the exciton absorption can be narrowed, and thus it is possible that the semiconductor optical modulator 1 in which the change in the absorption coefficient or the refractive index is increased and the propagation loss of light is reduced can be obtained.

When the digital alloy is formed by stacking a plurality of types of layers (a long-period layer 51c, a short-period layer 51d) that have different repeat thicknesses using semiconductor layers having different constituent elements or composition ratios, the minigap level of any period coincides with the level of the light holes, and the absorption by the light holes can be suppressed, so that the variation in the absorption spectrum can be reduced, the yield can be improved, and the production quantity can be stabilized.

Among the plurality of semiconductor layers, when the semiconductor layer (for example, the optical confinement layer (n-type optical confinement layer 4, p-type optical confinement layer 6, and n-type cladding layer 3) closer to the optical modulation layer (for example, the multiple quantum well optical modulation layer 5) than the end portion (for example, the n-electrode 8N and the p-electrode 8P) in the stacking direction is formed of the digital alloy, diffusion of a dopant such as zinc and sulfur can be prevented.

When the layer thickness of the digital alloy is equal to or less than 8 atomic layers, the width of the minigap that brings about the above-described effects is increased.

### DESCRIPTION OF REFERENCE NUMERALS AND SIGNS

1: semiconductor optical modulator, 2: InP substrate (semiconductor substrate), 3: n-type cladding layer, 4: n-type optical confinement layer, 5: multiple quantum well optical modulation layer (optical modulation layer), 51: quantum well layer, 51a: digital alloy layer, 51b: random alloy layer, 51c: long-period layer (digital alloy layer), 51d: short-period layer (digital alloy layer), 52: barrier layer, 6: p-type optical confinement layer, 7: p-type cladding layer, 8: electrode.

1. A semiconductor optical modulator that is formed by stacking a plurality of semiconductor layers including an optical modulation layer on a semiconductor substrate and emits light by modulating an intensity or a phase of light incident on the optical modulation layer, the semiconductor optical modulator comprising the optical modulation layer, wherein
the optical modulation layer is formed by alternately stacking a quantum well layer and a barrier layer having a band gap larger than that of the quantum well layer, and
the quantum well layer is formed using a digital alloy in which the semiconductor layers having a layer thickness of two or more atomic layers and having different constituent elements or composition ratios are alternately and repeatedly stacked.

2. The semiconductor optical modulator according to claim 1, wherein the semiconductor optical modulator is an electro-absorption type or a Mach-Zehnder type.

3. (canceled)

4. The semiconductor optical modulator according to claim 1, wherein the quantum well layer is formed by stacking the digital alloy and the random alloy.

5. The semiconductor optical modulator according to claim 1, wherein the optical modulation layer is a single quantum well layer formed of a quantum well layer having a thickness of 20 nm or more and 500 nm or less and the barrier layer.

6. The semiconductor optical modulator according to claim 1, wherein the barrier layer is formed of a digital alloy.

7. The semiconductor optical modulator according to claim 1, wherein the optical modulation layer has a thickness of 20 nm or more and 500 nm or less.

8. The semiconductor optical modulator according to claim 1, wherein the digital alloy is formed by stacking a plurality of types of layers having different repetition periods.

9. The semiconductor optical modulator according to claim 1, wherein, among the plurality of semiconductor layers, a semiconductor layer closer to the optical modulation layer than an end portion in a stacking direction is formed of the digital alloy.

10. The semiconductor optical modulator according to claim 1, wherein the layer thickness of the digital alloy is equal to or less than 8 atomic layers.

11. A semiconductor optical modulator that is formed by stacking a plurality of semiconductor layers including an optical modulation layer on a semiconductor substrate and emits light by modulating an intensity or a phase of light incident on the optical modulation layer, the semiconductor optical modulator comprising the optical modulation layer, wherein
the optical modulation layer is a semiconductor layer that is not formed with a quantum well and has a thickness of 20 nm or more and 500 nm or less and is formed using a digital alloy in which the semiconductor layers having a layer thickness of two or more atomic layers and having different constituent elements or composition ratios are alternately and repeatedly stacked.

12. The semiconductor optical modulator according to claim 11, wherein the semiconductor optical modulator is an electro-absorption type or a Mach-Zehnder type.

13. The semiconductor optical modulator according to claim 11, wherein the quantum well layer is formed by stacking the digital alloy and the random alloy.

14. The semiconductor optical modulator according to claim 11, wherein the digital alloy is formed by stacking a plurality of types of layers having different repetition periods.

15. The semiconductor optical modulator according to claim 11, wherein, among the plurality of semiconductor layers, a semiconductor layer closer to the optical modulation layer than an end portion in a stacking direction is formed of the digital alloy.

16. The semiconductor optical modulator according to claim 11, wherein the layer thickness of the digital alloy is equal to or less than 8 atomic layers.
